(19) United States
(12) Patent Application Publication
(10) Pub. No.: US 2005/0025296 A1
(43) Pub. Date: Feb. 3, 2005

(54) Wireless terminal priority call alerting

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: Richard J. Minnich;Fay, Sharpe, Fagan, Minnich & McKee, LLP, Seventh Floor, 1100 Superior Avenue, Cleveland, OH, 44114, US

(21) Appl. No.: 10/631,505

(22) Filed: Jul. 31, 2003

(51) Int. Cl. H04M 1/00

(52) U.S. Cl. 379/88.22; 379/373.01

(57) ABSTRACT

A method of providing an alert for an incoming call to a wireless terminal is provided. The method includes alerting with a priority alert which is different from a non-priority alert to indicate that the incoming call is a priority call. The method also includes notifying the wireless terminal that the incoming call is a priority call. The method can also include the calling party indicating that the call is a priority call and determining that the calling party is authorized to make priority calls to the wireless terminal. A system for providing an alert for an incoming call to a wireless terminal is provided. The system includes a Mobile Switching Center having means for receiving an indication that an incoming call to the wireless terminal is a priority call, and means for notifying the wireless terminal that the incoming call is a priority call.

The present invention relates to a system and method of providing an alert for an incoming call to a wireless terminal, and more particularly to a system and method of alerting that indicates an incoming call is a priority call.

Typically, wireless terminals, also known as cellular phones or mobile phones, provide an alert, also known as a ring, to indicate that an incoming call is being received. An alert can include one or more rings and may have a variety of tones or pattern of sounds. The subscriber can often choose which ring tone and/or number of rings their wireless terminal will produce for alerts. The wireless terminal can also be set to vibrate for alerts. The same alert is then used for all incoming calls.

The duration of the alert typically provides a balance between giving the subscriber enough time to answer the call while not ringing excessively. However, circumstances can arise in which the subscriber does not have enough time to answer an incoming call, such as when the terminal is hard to reach whine in a purse or coat. It is desirable to provide the subscriber with more time to answer an incoming call if the call is important.

In other situations, the subscriber may not want to answer most incoming calls unless they are particularly important. It is desirable to alert a called party that an incoming call is important.

### SUMMARY OF THE INVENTION

According to the present invention, a method of providing an alert for an incoming call to a wireless terminal is provided.

In accordance with a first aspect of the invention, the method includes alerting for an incoming call using a priority alert which is different from a non-priority alert to indicate that the incoming call is a priority call.

In accordance with a second aspect of the invention, the method includes notifying the wireless terminal that the incoming call is a priority call.

In accordance with another aspect of the invention, the method includes the calling party indicating that the call is a priority call.

In accordance with another aspect of the invention, the method includes determining that the calling party is authorized to make priority calls to the wireless terminal.

According to the present invention, a system for providing an alert for an incoming call to a wireless terminal is provided.

In accordance with another aspect of the invention, the system includes a Mobile Switching Center serving the wireless terminal. The MSC includes means for receiving an indication that an incoming call to the wireless terminal is a priority call, and means for notifying the wireless terminal that the incoming call is a priority call.

According to the present invention, a wireless terminal for providing an alert for an incoming call is provided. The wireless terminal includes means for producing a priority alert different from a non-priority alert to indicate that an incoming call is a priority call.

Other features, benefits and advantages of this invention will become apparent to those skilled in the art from the following detailed description of the preferred embodiments, when read in light of the accompanying drawings.

### BRIEF DESCRIPTION OF THE DRAWINGS

The invention may take form in certain components and structures, preferred embodiments of which will be illustrated in the accompanying drawings wherein:

FIG. 1 is a block diagram illustrating the invention; and

FIG. 2 illustrates the steps of the invention.

### DETAILED DESCRIPTION OF THE INVENTION

It is to be understood that the specific devices and processes illustrated in the attached drawings, and described in the following specification are simply exemplary embodiments of the inventive concepts defined in the appended claims. Hence, specific examples and characteristics relating to the embodiments disclosed herein are not to be considered as limiting, unless the claims expressly state otherwise.

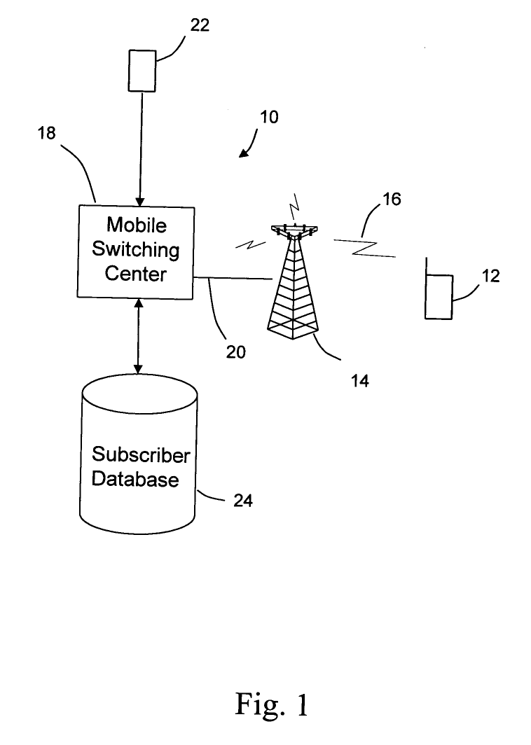

Referring to FIG. 1, a portion of a wireless communications network is shown generally at 10. The wireless communications network 10 can be any suitable known wireless communications network including but not limited to CDMA, GSM, etc. A wireless communications network provider (not shown) provides the use of the wireless communications network to subscribers. A subscriber can communicate over the wireless communications network 10 using a wireless terminal 12. The wireless terminal 12, can be capable of handling various media such as data, text, special application, video, etc., as well as voice communications. Examples can include, but are not limited to 3GPP and 3GPP2 terminals, or any other wireless terminals capable of communicating over the wireless communications network 10. For the purposes of this invention, the person operating the wireless terminal 12 shall be referred to as the called party.

The wireless communications network 10 includes a base station 14 communicating with the wireless terminal 12 over an air interface 16. The wireless communications network 10 also includes a Mobile Switching Center (MSC) 18 communicating with the base station 14 using any suitable known connection 20. The MSC 18 handles the communications of the wireless terminal 12 with the communications network 10 including call set-ups, registration and routing incoming calls to the wireless terminal. The MSC 18, also referred to as the serving MSC, can be the wireless terminal's home MSC or it can be a different MSC in the wireless communications network 10 if the wireless terminal 12 is roaming.

A calling party phone 22 calls the wireless terminal 12. The calling party phone 22 can be another wireless terminal or any suitable known phone for communicating with the wireless terminal 12 including a wire line telephone. The incoming call coming from the calling party phone 22 can be from any known telecommunications network, including but not limited to a wireless communications network, a wireline network, the Public Switched Telephone Network, an Internet Protocol (IP) network, etc.

The wireless communications network provider can offer the invention only to parties subscribing to the service, if so desired. A subscriber database 24 can be used to indicate whether the called party subscribes and thus can receive priority calls. The subscriber database 24 is typically stored in the home MSC 18, though it can be stored in and/or made available to any of the MSCs in the wireless communications network 10 in any suitable known manner.

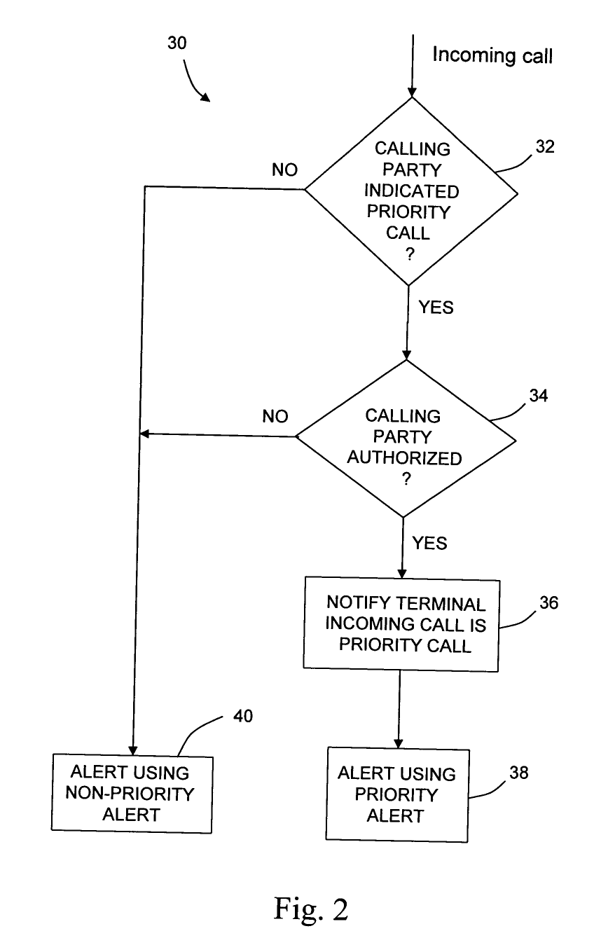

Referring now to FIG. 2, a method of providing an alert for an incoming call to a wireless terminal is shown generally at 30. In one embodiment, the method includes the calling party indicating that the call is a priority call at 32 when making the call to the wireless terminal 12. For example, the calling party can dial a priority code, such as “*##”, where ## are predetermined numbers, or any other suitable dialed code, to indicate to the wireless communications network 10 that the incoming call is considered a priority call. The priority code notifies the MSC 18 to treat the incoming call as a priority call.

In another embodiment, each subscriber can provide a list of phone numbers from which a priority call can be received by the subscriber to reduce abuse of this service. The list can be included in the subscriber database 24 and associated with the subscriber. The subscriber can add, remove or otherwise edit their numbers in any suitable known manner. At 34, it is determined whether the calling party 22 is authorized to make priority calls to the wireless terminal 12. The MSC 18 can access the subscriber database 24 in any suitable known manner and use it to verify that the calling party is authorized. If the calling party is authorized and the priority code has been received, the MSC 18 treats the incoming call as a priority call.

In another embodiment, all calls from a group of one or more calling parties, referred to as priority calling parties, will be considered priority calls. The subscriber provides the list of priority calling parties to the network 10, for example using their phone numbers, which are entered into the subscriber database in any suitable known manner. In this embodiment, a priority code does not need to be entered when making a call, since all calls made by that priority party are treated as priority calls. When the MSC 18 receives an incoming call from a calling party listed as a priority calling party on the subscriber database 24 the MSC treats the incoming call as a priority call.

The method also includes notifying the wireless terminal that the incoming call is a priority call at 36. When a calling party places a priority call to the wireless terminal 12, the call is routed to the serving MSC 18 over the communications network 10. The serving MSC 18 then routes the call to the wireless terminal 12 using the base station 14. The serving MSC 18 uses suitable messaging protocol to notify the wireless terminal that the incoming call is a priority call.

Upon receiving the message from the serving MSC 18 that the incoming call is a priority call, the wireless terminal 12 uses the priority alert at 38 to indicate that the incoming call is a priority call. The priority alert is different from a non-priority alert thereby enabling the called party to distinguish between priority and non-priority incoming calls. The priority alert can be made different than the non-priority alert in any suitable known manner. For example, different ring tones and/or a different number of rings can be used. More rings can be used for a priority call to provide the called party more time to answer the call. Vibrations can be used for rings as an alert also. In one embodiment of the invention, the subscriber can choose the different alerts for the priority and non-priority alerts using any suitable known means for choosing alerts. These alerts can be stored by the wireless terminal 12 and used for priority and non-priority incoming calls.

The invention has been described with reference to preferred embodiments. Obviously, modifications and alterations will occur to others upon reading and understanding the preceding specification. It is intended that the invention be construed as including all such modifications and alterations insofar as they come within the scope of the appended claims or the equivalents thereof.

1. A method of providing an alert for an incoming call to a wireless terminal comprising:
alerting with a priority alert, said priority alert being different from a non-priority alert to indicate that the incoming call is a priority call.

2. The method defined in claim 1 wherein the alerting step comprises producing a priority alert having a different ring tone than a non-priority alert.

3. The method defined in claim 1 wherein the alerting step comprises producing a priority alert having a different number of rings than a non-priority alert.

4. The method defined in claim 3 wherein the alerting step comprises producing a priority alert having more rings than a non-priority alert.

5. The method defined in claim 1 further comprising:
the calling party indicating that the call is a priority call.

6. The method defined in claim 5 wherein the indicating step includes the calling party dialing a priority code to indicate that the call is a priority call.

7. The method defined in claim 5 further comprising:
determining that the calling party is authorized to make priority calls to the wireless terminal.

8. The method defined in claim 1 further comprising:
notifying the wireless terminal that the incoming call is a priority call.

9. The method defined in claim 1 further comprising:
the calling party indicating that the call is a priority call;
determining that the calling party is authorized to make priority calls to the wireless terminal; and
notifying the wireless terminal that the incoming call is a priority call.

10. The method defined in claim 9 wherein the notifying step comprises:
sending a message from a Mobile Switching Center to the wireless terminal notifying the wireless terminal that the incoming call is a priority call.

11. The method defined in claim 1 further comprising:
providing a list of one or more priority calling parties; and
notifying the wireless terminal that an incoming call from a priority calling party is a priority call.

12. A wireless communications network for providing communications to a wireless terminal comprising:
a Mobile Switching Center (MSC) serving the wireless terminal, said MSC comprising:
means for receiving an indication that an incoming call to the wireless terminal is a priority call, and
means for notifying the wireless terminal that the incoming call is a priority call.

13. The wireless communications network defined in claim 12 further comprising:
a subscriber database used for determining that a calling party can make a priority call to the wireless terminal.

14. The wireless communications network defined in claim 13 wherein the MSC includes means for determining that the calling party can make a priority call to the wireless terminal.

15. A wireless terminal for communicating over a wireless communications network comprising:
means for producing a priority alert to indicate that an incoming call is a priority call, said priority alert being different from a non-priority alert.

16. The wireless terminal defined in claim 15 further comprising:
means for selecting the priority alert; and
means for selecting the non-priority alert.

17. The wireless terminal defined in claim 16 wherein the priority alert has a different ring tone than the non-priority alert.

18. The wireless terminal defined in claim 17 wherein the priority alert has a different number of rings than the non-priority alert.

19. The wireless terminal defined in claim 18 wherein the priority alert has more rings than the non-priority alert.
